(19) United States
(12) Patent Application Publication
(10) Pub. No.: US 2007/0080903 A1
(43) Pub. Date: Apr. 12, 2007

(54) Plasma display device and power supply used therein

(76) Inventor: Dong-Myung Lee, Yongin-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/540,787

(22) Filed: Sep. 28, 2006

(30) Foreign Application Priority Data
Oct. 11, 2005 (KR) 10-2005-0095361

(51) Int. Cl. G09G 3/28

(52) U.S. Cl. 345/68

(57) ABSTRACT

A plasma display device includes a PDP, a driver for supplying driving signals to the PDP, and a power supply for supplying a power source to the driver. The power supply includes first and second resistors coupled in series between two terminals for outputting a predetermined output voltage, and a shunt regulator for maintaining a node of the first and second resistors at a constant voltage by coupling a node of the first and second resistors to a reference terminal. At least one of the first and second resistors is a variable resistor of which a resistance is changed by a change of temperature. With such a structure, a low discharge may be prevented when the power supply changes a predetermined voltage used in the plasma display device according to a change of temperature.

### CROSS-REFERENCE TO RELATED APPLICATION

This application claims priority to and the benefit of Korean Patent Application No. 10-2005-0095361 filed in the Korean Intellectual Property Office on Oct. 11, 2005, the entire contents of which is incorporated herein by reference.

### BACKGROUND OF THE INVENTION

1. Field of the Invention

The present invention relates to a plasma display device and a power supply used therein.

2. Description of the Related Technology

A plasma display device is a display device using a plasma display panel (PDP) which uses plasma generated by gas discharge to display characters or images.

One frame of the plasma display device is divided into a plurality of subfields respectively having a weight, and each subfield includes a reset period, an address period, and a sustain period. The reset period is used for initializing the state of each discharge cell so as to facilitate an addressing operation on the discharge cell, the address period is used for selecting turn-on/turn-off cells and accumulating wall charges to the turn-on cells (i.e., addressed cells), and the sustain period is used for causing a discharge for displaying an image on the addressed cells.

As such, the plasma display device displays images by using discharge characteristics for the respective periods at each subfield. However, the discharge characteristics are substantially dependent on the temperature of the plasma display device. That is, when the temperature of the PDP is decreased, charges move slower. Accordingly, in this case, a low discharge may be generated because it takes a longer time for wall charges to be accumulated. On the other hand, when the temperature of PDP is increased, the charges move more rapidly. Accordingly, the low discharge may be generated because a discharge-response speed becomes faster, and thus the charges are self-eliminated.

The above information disclosed in this Background section is only for enhancement of understanding of the background of the invention and therefore it may contain information that does not form the prior art that is already known in this country to a person of ordinary skill in the art.

### SUMMARY OF CERTAIN INVENTIVE ASPECTS

The present invention has been made in an effort to provide a plasma display device and a power supply used therein having advantages of reducing low discharge resulting from a change of temperature of the PDP.

One embodiment is a plasma display device including a plasma display panel (PDP) having a plurality of row electrodes and a plurality of column electrodes, a driver configured to apply a driving signal to the plurality of row and column electrodes, and a power supply configured to supply power to the driver. The power supply includes a capacitor of which both terminals are configured to be charged with an output voltage, first and second resistors coupled in series between the first and second terminals of the capacitor, and a shunt regulator configured to maintain a node of the first and second resistors at a substantially constant voltage by coupling a node of the first and second resistors to a reference terminal, where at least one of the first and second resistors is a variable resistor of which a resistance is changed by a change of a temperature.

Another embodiment is a power supply including a switch coupled to a first coil of a transformer. The power supply is configured to output an output voltage to an output terminal according to a duty of the switch. The power supply includes first and second resistors coupled in series between first and second output terminals, and a shunt regulator configured to maintain a node of the first and second resistors at a substantially constant voltage by coupling the node of the first and second resistors to a reference terminal, where at least one of the first and second resistors is a variable resistor of which a resistance is changed by a change of a temperature.

Another embodiment is a plasma display device including a plasma display panel (PDP) having a plurality of row electrodes and a plurality of column electrodes, a driver configured to apply a driving signal to the plurality of row and column electrodes, and a power supply configured to supply an output voltage to the driver. The power supply includes first and second resistors coupled in series between the first and second terminals of the output voltage, and a shunt regulator configured to maintain a node of the first and second resistors at a substantially constant voltage, where at least one of the first and second resistors is a variable resistor of which a resistance is changed by a change of a temperature.

### BRIEF DESCRIPTION OF THE DRAWINGS

FIG. 1 shows a plasma display device according to an embodiment.

FIG. 2 is a driving waveform diagram of a plasma display device according to an embodiment.

FIG. 3 is a drawing showing a DC-DC converter configured to generate a voltage Va among a plurality of DC-DC converters disposed in a power supply for a plasma display device according to a first embodiment.

FIG. 4 is a drawing showing a DC-DC converter configured to generate a voltage Va among a plurality of DC-DC converters disposed in a power supply for a plasma display device according to another embodiment.

### DETAILED DESCRIPTION OF CERTAIN INVENTIVE EMBODIMENTS

In the following detailed description, only certain inventive embodiments have been shown and described, simply by way of illustration. As those skilled in the art would realize, the described embodiments may be modified in various ways, without departing from the spirit or scope of the present invention. Accordingly, the drawings and description are to be regarded as illustrative in nature and not restrictive.

Throughout this specification and claims which follow, unless explicitly described to the contrary, when it is stated that one element is coupled to another element, it includes a state in which the two elements are directly coupled as well as a state in which the two elements are electrically coupled with another element provided between them. In addition, the word “comprise” or “include” or variations such as “comprises” “includes” or “comprising” “including” will be understood to imply the inclusion of stated elements but not the exclusion of any other elements.

Wall charges mentioned in the following description mean charges formed and accumulated on a wall (e.g., a dielectric layer) close to an electrode of a discharge cell. The wall charge will be described as being “formed” or “accumulated” on the electrode on a wall (e.g., a dielectric layer) close to an electrode of a discharge cell.

A plasma display device according to an embodiment and a power supply apparatus used therein will now be described with reference to the accompanying drawings.

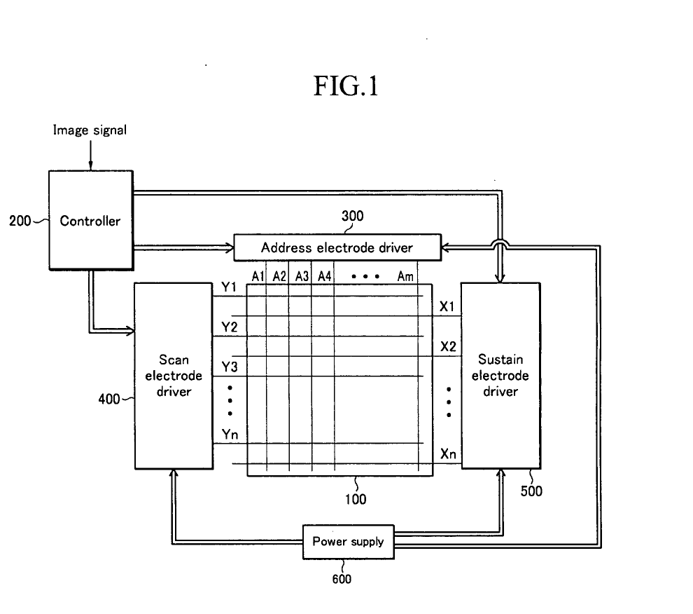

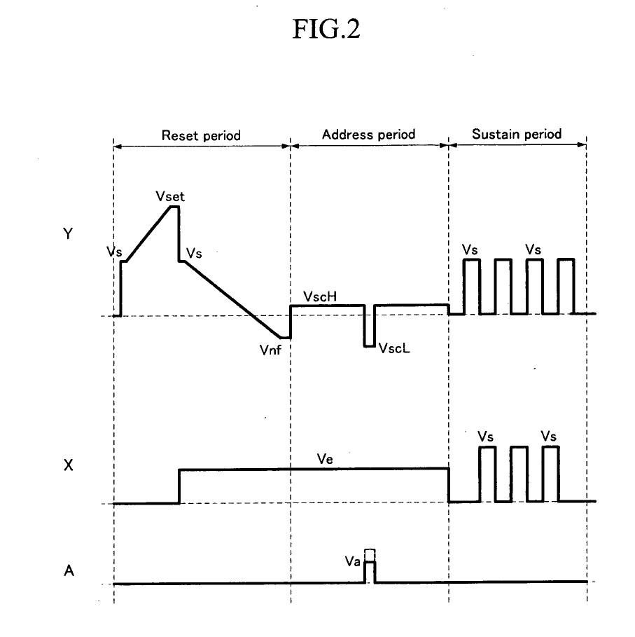

First, a plasma display device according to an embodiment and a driving method thereof will be described with reference to FIG. 1 and FIG. 2.

FIG. 1 shows a plasma display device according to an embodiment

As shown in FIG. 1, the plasma display device includes a plasma display panel (PDP) 100, a controller 200, an address driver 300, a scan electrode driver 400, a sustain electrode driver 500, and a power supply 600.

The PDP 100 has a plurality of address electrodes A1-Am arranged in a column direction and a plurality of sustain electrodes X1-Xn arranged in a row direction. Generally, the sustain electrodes X1-Xn are formed in correspondence to the respective scan electrodes Y1-Yn, and respective portions thereof are coupled to each other. In addition, the PDP 100 includes a substrate in which the sustain and scan electrodes X1-Xn and Y1-Yn are arranged (not shown), and another substrate in which the address electrodes A1-Am are arranged (not shown). The two substrates are placed facing each other with a discharge space therebetween so that the scan electrodes Y1-Yn and the address electrodes A1-Am may substantially perpendicularly cross each other and the sustain electrodes X1-Xn and the address electrodes A1-Am may substantially perpendicularly cross each other. Here, the discharge spaces are formed at a crossing regions of the address electrodes A1-Am and the sustain and scan electrodes X1-Xn and Y1-Yn. This structure is an example of the PDP 100, and the inventive aspects described herein can be applied to panels of other structures as well.

The address electrode driver 300 receives the address electrode driving control signal from the controller 200 and applies a display data signal to the respective address electrodes A1-Am for selecting turn-on discharge cells.

The scan electrode driver 400 receives the scan electrode driving control signal from the controller 200 and applies a driving voltage to the respective scan electrodes Y1-Yn.

The sustain electrode driver 500 receives the sustain electrode driving control signal from the controller 200 and applies a driving voltage to the respective sustain electrodes X1-Xn.

The power supply 600 generates a plurality of voltages used for the plasma display device, and supplies the voltages to the respective drivers 300, 400, and 500. The power supply 600 includes a plurality of DC-DC converters so as to generate a plurality of voltages used in the plasma display device. The respective drivers 300, 400, and 500 apply the voltages supplied from the power supply 600 to the respective electrodes (the address, scan, and sustain electrodes) of the PDP 100 for driving the PDP 100. Here, the power supply 600 according to an embodiment generates and supplies voltages that change according to the temperature of the PDP or of the surroundings thereof as described hereinafter.

FIG. 2 is a driving waveform diagram of a plasma display device according to an embodiment. FIG. 2 illustrates a driving waveform for only one subfield among a plurality of subfields for convenient description. The same waveform as the driving waveform shown in FIG. 2 may be applied for other subfields, except that the number of sustain pulses is controlled to correspond to data weighted values of each subfield. In addition, a discharge cell described is formed in a discharge space at crossing regions of an A electrode, an X electrode, and a Y electrode.

As shown in FIG. 2, during the rising period of the reset period, the Y electrode is applied with a rising waveform that gradually increases a voltage of the Y electrode from a voltage Vs to a voltage Vset while maintaining the A and X electrodes at a reference voltage (0V in FIG. 2). FIG. 2 illustrates that the voltage of the Y electrode increases according to a ramp pattern. While the voltage of the Y electrode increases, a weak discharge occurs between the Y and X electrodes and between the Y and A electrodes. Accordingly, negative (−) wall charges are formed on the Y electrode, and positive (+) wall charges are formed on the X and A electrodes. The wall charge may be maintained at a discharge firing voltage. Such a process of forming wall charges is disclosed in U.S. Pat. No. 5,745,086 by Weber, which is incorporated herein by reference. The voltage Vset is high enough to fire a discharge in cells in any state because every cell has to be initialized in the reset period.

During the falling period of the reset period, the voltage of the Y electrode is gradually decreased from the voltage Vs to a negative voltage Vnf while maintaining the X electrode at a voltage Ve. While the voltage of the Y electrode decreases, a weak discharge occurs between the Y and X electrodes and between the Y and A electrodes. Accordingly, the negative (−) wall charges formed on the Y electrode and the positive (+) wall charges formed on the X and A electrodes are eliminated. The voltage Vnf-Ve is usually set close to a discharge firing voltage between the Y and X electrodes. Then, the wall voltage between the Y and X electrodes becomes near 0V, and accordingly, the discharge cells are initialized.

Subsequently, during the address period for selection of turn-on cells, a scan pulse of a voltage VscL and an address pulse of a voltage Va are respectively applied to Y and A electrodes of the turn-on cells while maintaining the X electrode at the voltage Ve. In addition, non-selected Y electrodes are biased at a voltage VscH that is higher than the voltage VscL, and the reference voltage (0V) is applied to the A electrode of the turn-off cells (i.e., cells to be turned off). An address discharge is then generated in a cell defined by the A electrode that is applied with the voltage Va and the Y electrode that is applied with the voltage VscL, and accordingly, positive (+) wall charges are formed on the Y electrode and negative (−) wall charges are formed on the A electrode and the X electrode.

Subsequently, during the sustain period, a sustain discharge pulse having a voltage Vs is alternately applied to the X and Y electrodes, and accordingly, a sustain discharge is generated in the discharge cells selected during the address period.

In a driving method of the plasma display device according to an embodiment, the voltage Va (i.e., address voltage) is changed according to the temperature of the PDP or of the surroundings thereof.

When the temperature of the PDP is decreased, the charges move slower, and accordingly, the discharge-speed becomes slow and it takes a longer time for the wall charges to accumulate. Accordingly, a low discharge is generated because the discharge cells insufficiently accumulate wall charges by the application of the voltages VscL and Va during the address period. Meanwhile, when the temperature is increased, the charges move more rapidly. In this case, the address discharge-response speed becomes faster, and accordingly, the wall charges may be self-eliminated or dissipated into peripheral discharge cells. Thus, a low discharge may be generated because the wall charges are insufficiently accumulated during the address period.

Thus, according to an embodiment, when the temperature of the PDP or surroundings thereof increases during the address period, the low discharge may be prevented by an increase of the voltage Va. A1so, when the temperature of PDP or surroundings thereof decreases, the low discharge may be prevented by the increase of the voltage Va.

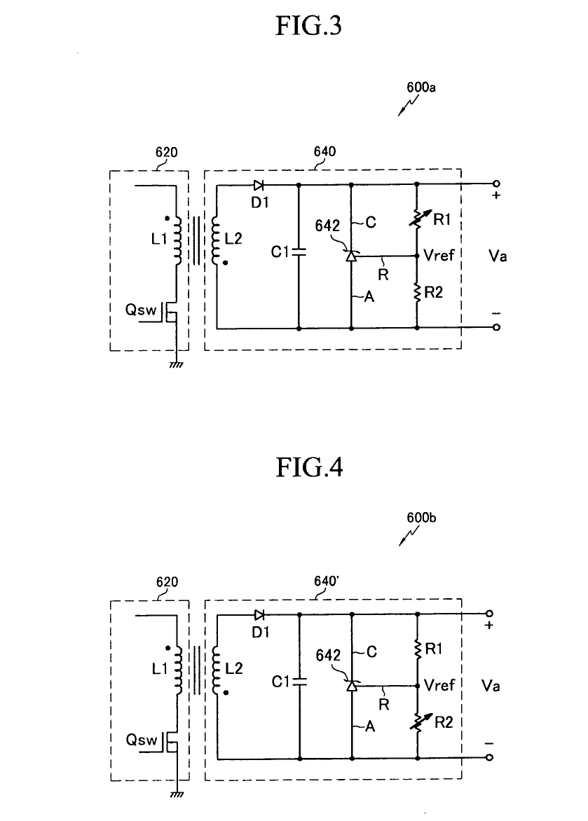

According to an embodiment, the power supply 600 generates the voltage Va which is changed according to the temperature and supplies the changed voltage Va to the address electrode driver 300. A method for the power supply 600 generating the variable voltage Va depending on the temperature will be described with reference to FIG. 3 and FIG. 4.

FIG. 3 is a drawing showing a DC-DC converter for generating a voltage Va among a plurality of DC-DC converters disposed in a power supply for a plasma display device according to an embodiment. In FIG. 3, only an output unit 640 that is directly related to an embodiment is described in detail, for convenient description, and other elements are schematically described or not described.

As shown in FIG. 3, a DC-DC converter 600 a according to an embodiment includes a power supply 620 and an output unit 640. In addition, although not shown in FIG. 3, the DC-DC converter 600 a according to the embodiment may include a switch controller for controlling duty of a switch QW by the feedback of feedback information corresponding to an output voltage Va.

The power supply 620 includes a first coil L1 of a transformer and a switch Qsw, and controls a duty of the switch Qsw to supply power to the output unit 640. A method of supplying a power to the output unit 640 according to the duty of the switch Qsw will not be described in detail.

The output unit 640 includes a second coil L2 of a transformer, a diode D1, a capacitor C1, a shunt regulator 642, and resistors R1 and R2. According to the embodiment, the resistor R1 is given as a variable resistor of which resistance varies depending on temperature.

An anode of the diode D1 is connected to one end of the second coil of the transformer, and a cathode of the diode D1 is connected to the positive Va output. The variable resistor R1 is coupled in series to the resistor R2 between the cathode of the diode D1 and the other end of the second coil L2 of the transformer. A reference terminal R of the shunt regulator 642 is coupled to a node of the variable resistor R1 and the resistor R2, and a cathode terminal C and an anode terminal A are respectively coupled to the cathode of the diode D1 and the other end of the second coil L2 of the transformer. Also, although not shown in FIG. 3, an additional resistor and a photo coupler may be formed in a series between the node of the capacitor C1 and the variable resistor and the cathode terminal of the shunt regulator 642. The photo coupler transmits the feedback information to the power supply 620.

Generally, the output unit 640 is supplied with a power from the power supply 620, and outputs an output voltage Va to both ends of the capacitor Cl through the second coil L2, the diode D1, and the capacitor C1. In the embodiment shown, the shunt regulator 642, the variable resistor R1, and the resistor R2 are added, and accordingly, the output voltage Va changes according to the temperature.

Furthermore, the shunt regulator 642 may be an IC (Integrated Circuit).The shunt regulator 642 may use elements such as programmable shunt regulators TL431 or KA431, and the reference terminal R may be maintained at a constant reference voltage Vref based on the characteristics of the element. In FIG. 3, a relationship of the reference voltage Vref and the voltage Va is given as Equation 1 due to distribution of the resistors R1 and R2.

$$Vref = ( \frac{R 2}{R 1 + R 2} ) \times Va \qquad ( Equation 1 )$$

In Equation 1, the voltage Vref is given as a reference voltage of the shunt regulator 642, which is maintained at the constant voltage based on the characteristics of the element, and is given as predetermined values for the respective elements. When Equation 1 is again expressed as the voltage Va, Equation 1 becomes Equation 2 as follows.

$$Va = ( 1 + \frac{R 1}{R 2} ) \times Vref \qquad ( Equation 2 )$$

As shown in Equation 2, the voltage Va is changed according to the resistors R1 and R2 because a value of the voltage Vref is fixed. According to the embodiment of FIG. 3, the voltage Va is changed according to the temperature because the resistor R1 is a variable resistor of which resistance varies depending on the temperature of the PDP 100 or the surroundings thereof. The temperature-dependant variable resistors will not be described in detail. A temperature-dependant variable resistor R1 is placed in the power supply 600, and accordingly, the temperature of the PDP or the surroundings thereof is not directly reflected on the same. However, a resistance of the variable resistor R1 may be indirectly changed according to the temperature of the PDP or the surroundings because the temperature of the PDP is changed according to the temperature of the power supply 600. Accordingly, it may be perceived that the resistance of the variable resistor R1 placed in the power supply 600 reflects the temperature of PDP or the surroundings thereof.

In FIG. 3, when the variable resistor R1 is set to have a positive temperature coefficient (PTC) characteristic wherein the resistance is increased by an increase of temperature, the output voltage Va is increased by an increase of temperature as shown in Equation 2. When the variable resistor R1 is set to have a negative temperature coefficient (NTC) characteristic wherein the resistance is decreased by an increase of the temperature, the output voltage Va is increased by a decrease of temperature as shown in Equation 2.

According to the embodiment of FIG. 3, the variable resistor R1 can be realized so as to have a PTC or NTC characteristic, so that a low discharge may be prevented by an increase of the voltage Va according to either change of the temperature.

In FIG. 3, it is one example in which the resistance of the variable resistor R1 is changed. The resistor R2 may also vary according to a change of temperature as shown in FIG. 4.

FIG. 4 is a drawing showing a DC-DC converter 640b for generating a voltage Va among a plurality of DC-DC converters disposed in a power supply for a plasma display device according to an embodiment. As shown in FIG. 4, the embodiment is the same as the embodiment of FIG. 3, except that the resistor R2 varies according to a change of temperature in an output unit 640′.

In FIG. 4, when the variable resistor R2 is set to have the PTC characteristic, the resistance of the resistor R2 is reduced by a decrease of temperature and the output voltage Va is increased by a decrease of temperature, as shown in Equation 2. Next, when the variable resistor R2 is set to have the NTC characteristic, the resistance of the resistor R2 is decreased by an increase of temperature and the output voltage Va is increased by an increase of temperature, as shown in Equation 2.

According to the embodiment of FIG. 3, the variable resistor R2 can be realized so as to have the PTC or NTC characteristic, so that a low discharge may be prevented by an increase of the voltage Va according to a change of the temperature.

Meanwhile, it is one example that the resistances of the variable resistor R1 and R2 are respectively changed in FIG. 3 and FIG. 4. Accordingly, both the resistors R1 and R2 may have varying resistances according to a change of the temperature. In such embodiments, the low discharge may be prevented by an increase of the voltage Va according to an increase of temperature when the resistor R1 is set to have the PTC characteristic and the resistor R2 is set to have the NTC characteristic. In addition, the low discharge may be prevented by an increase of the voltage Va according to a decrease of temperature when the resistor R1 is set to have the NTC characteristic and the resistor R2 is set to have the PTC characteristic.

According to the embodiments described above, the voltage Va is changed according to a change of temperature in order to solve a low discharge according to temperature of a PDP or of the surroundings thereof. However, it is not limited thereto. Other voltages (for example, Vset, Vnf, Vs, or the like) may be additionally or alternatively changed according to a change of temperature when the same or similar structure as the output units of the DC-DC converter of FIG. 3 and FIG. 4 is used.

While this invention has been described in connection with what is presently considered to be practical embodiments, it is to be understood that the invention is not limited to the disclosed embodiments, but, on the contrary, is intended to cover various modifications and arrangements.

As described above, according to embodiments, the low discharge may be prevented by a change of a voltage according to a change of temperature.

What is claimed is:

1. A plasma display device, comprising:
a plasma display panel (PDP) having a plurality of row electrodes and a plurality of column electrodes;
a driver configured to apply a driving signal to the plurality of row and column electrodes; and
a power supply configured to supply power to the driver,
wherein the power supply comprises:
a capacitor of which both terminals are charged with an output voltage;
first and second resistors coupled in series between the first and second terminals of the capacitor, and
a shunt regulator configured to maintain a node of the first and second resistors at a substantially constant voltage by coupling a node of the first and second resistors to a reference terminal,
wherein at least one of the first and second resistors is a variable resistor of which a resistance is changed by a change of a temperature.

2. The plasma display device of claim 1, wherein the temperature corresponds to the temperature of the PDP or surroundings thereof.

3. The plasma display device of claim 1, wherein the resistance of the first resistor is increased by an increase of temperature.

4. The plasma display device of claim 1, wherein the resistance of the first resistor is decreased by a decrease of temperature.

5. The plasma display device of claim 1, wherein the resistance of the second resistor is increased by a decrease of temperature.

6. The plasma display device of claim 1, wherein the resistance of the second resistor is increased by an increase of temperature.

7. The plasma display device of claim 1, wherein the shunt regulator has cathode and anode terminals respectively coupled with the first and second terminals of the capacitor.

8. The plasma display device of claim 1, wherein the output voltage is used as a voltage of the driving signal.

9. A power supply including a switch coupled to a first coil of a transformer, the power supply configured to output an output voltage to an output terminal according to a duty of the switch, the power supply comprising:
first and second resistors coupled in series between first and second output terminals; and
a shunt regulator configured to maintain a node of the first and second resistors at a substantially constant voltage by coupling the node of the first and second resistors to a reference terminal,
wherein at least one of the first and second resistors is a variable resistor of which a resistance is changed by a change of a temperature.

10. The power supply of claim 9, wherein the resistance of the first resistor is increased by an increase of temperature.

11. The power supply of claim 9, wherein the resistance of the first resistor is decreased by a decrease of temperature.

12. The power supply of claim 9, wherein the resistance of the second resistor is increased by a decrease of temperature.

13. The power supply of claim 10, wherein the resistance of the second resistor is increased by a decrease of temperature.

14. The power supply of claim 9, wherein the resistance of the second resistor is increased by an increase of temperature.

15. The power supply of claim 11, wherein the resistance of the second resistor is increased by an increase of temperature.

16. The power supply of claim 9, wherein the output voltage is applied to a plasma display device.

17. The power supply of claim 16, wherein the output voltage is used as a voltage of the driving signal.

18. A plasma display device, comprising:
a plasma display panel (PDP) having a plurality of row electrodes and a plurality of column electrodes;
a driver configured to apply a driving signal to the plurality of row and column electrodes; and
a power supply configured to supply an output voltage to the driver,
wherein the power supply comprises:
first and second resistors coupled in series between the first and second terminals of the output voltage, and
a shunt regulator configured to maintain a node of the first and second resistors at a substantially constant voltage,
wherein at least one of the first and second resistors is a variable resistor of which a resistance is changed by a change of a temperature.

19. The plasma display device of claim 18, wherein the temperature corresponds to the temperature of the PDP.

20. The plasma display device of claim 18, wherein the output voltage is used as a voltage of the driving signal..
